(19) United States
(12) Patent Application Publication
(10) Pub. No.: US 2020/0020242 A1
(43) Pub. Date: Jan. 16, 2020

(54) Student Assessment and Reporting

(71) Applicant: FastBridge Learning L.L.C., Minneapolis, MN (US)

(72) Inventors: Theodore J. Christ, Edina, MN (US); Terri Lynn Theriault Soutor, Minnetonka, MN (US); Zoheb Hassan Borbora, Minneapolis, MN (US)

(21) Appl. No.: 16/507,472

(22) Filed: Jul. 10, 2019

Related U.S. Application Data
(60) Provisional application No. 62/696,117, filed on Jul. 10, 2018.

(51) Int. Cl. G09B 7/00; G06F 16/23; G06N 5/04

(52) U.S. Cl. CPC G09B 7/00; G06N 5/04; G06F 16/2379

(57) ABSTRACT

An example system for assessing student progress includes: a processor; and memory encoding instructions which, when executed by the processor, cause the system to: assist in the identification and analysis of a student performance issue; develop a plan to address the student performance issue by improving student performance; assist in implementation of the plan over time; and evaluate success of the plan in addressing the student performance issue by monitoring assessments of students.

### BACKGROUND

Students are typically tested or otherwise assessed as they progress through a curriculum. These tests can be used for various purposes, such as assessing the students' progress and determining the advancement of students based upon various factors. Educators, such as teachers, school administrators, and government agencies like departments of education, can track this information to improve the educational services provided to the students.

### SUMMARY

Embodiments of the disclosure are directed to systems and methods that provide screening, progress monitoring, skills analysis, and/or informing instruction for students. The systems and methods can also provide research-based tools that allow educators to make informed educational decisions for students, deliver instruction and intervention, and/or obtain professional development.

The details of one or more techniques are set forth in the accompanying drawings and the description below. Other features, objects, and advantages of these techniques will be apparent from the description, drawings, and claims.

### DESCRIPTION OF THE FIGURES

FIG. 1 shows an example system for providing testing and/or assessment of students.

FIG. 2 shows an example user interface generated by a testing/assessment computing device of the system of FIG. 1.

FIG. 3 shows an example screening to intervention report generated by the testing/assessment computing device of FIG. 1.

FIG. 4 shows an example group screening report generated by the testing/assessment computing device of FIG. 1.

FIG. 5 shows another view of the group screening report of FIG. 4.

FIG. 6 shows an example excerpt of the groups screening report of FIG. 5.

FIG. 7 shows an example user interface of the testing/assessment computing device of FIG. 1 with help functionality.

FIG. 8 shows another example user interface of the testing/assessment computing device of FIG. 1 with help functionality.

FIG. 9 shows another example user interface of the testing/assessment computing device of FIG. 1 with reports filtering functionality.

FIG. 10 shows an example user interface of the testing/assessment computing device of FIG. 1 with training information.

FIG. 11 shows another example user interface of the testing/assessment computing device of FIG. 1 with training information.

FIG. 12 shows an example user interface of the testing/assessment computing device of FIG. 1 with tasks listed thereon.

FIG. 13 shows an example user interface of the testing/assessment computing device of FIG. 1 allowing for segregation of data.

FIG. 14 shows an example user interface of the testing/assessment computing device of FIG. 1 which imports assessment settings from previous years.

FIG. 15 shows example components of the testing/assessment computing device of FIG. 1.

FIG. 16 shows another example system providing testing and/or assessment of students.

FIG. 17 shows an example data warehousing environment for the system of FIG. 1.

### DETAILED DESCRIPTION

The present disclosure is directed to systems and methods for screening, progress monitoring, skills analysis, and/or informing instruction for students and/or educators.

Such screening, progress monitoring, skills analysis, and/or informing instruction can be specific to certain subjects, such as reading or math. Such analyses can also be applied to non-academic subjects, such as social development, to measure developmental milestones, social-emotional behavior, etc.

In some examples, this is accomplished through assessments and the like. In an example provided herein, a group of students, such as a class, grade level, school, district, etc., is assessed based upon the students' reading skills. Various assessments can be provided to assess and track the students' progress with reading throughout a school year. The assessments can include a combination of curriculum-based measurement (CBM) and computer adaptive tests (CAT) that are used, for example, to identify at-risk students and intervene to prevent students from falling behind.

Examples of such assessments include, without limitation:
earlyReading—an evidence-based assessment designed to screen and monitor PreK-1 students, yet may be administered to older students as needed. Of 12 subtests, four key subtests derived from the latest research are suggested per benchmark period—fall, winter, spring—varying over time. They provide a trusted, insightful composite score indicating students' readiness or risk.
CBMreading (Curriculum-Based Measurement for Reading)—a simple, efficient, evidence-based assessment used for universal screening in grades 1-8, and progress monitoring for grades 1-12 in English or Spanish. A teacher listens and evaluates a student's performance, including accuracy, error types, and qualitative features, while they read aloud from a grade-level passage for one minute.
CBMcomp (Curriculum-Based Measurement for Comprehension)—an optional add on to CBMreading passages for grades 1-8 for screening and progress monitoring. CBMcomp measures a student's comprehension of the passage that was just read by using story retell and a series of 10 questions about the passage.
aReading (Adaptive Reading)—a simple, efficient computer-adaptive measure of broad reading for grades K-12 that is individualized for each student, but may be delivered in a group format in about 15-30 minutes. It is designed for Universal Screening.
AUTOreading—emerged from many years of research as a fully automated, computer administered measure of decoding, word identification, and comprehension for use to screen and monitor student progress across grade levels K-12. AUTOreading includes eight individual testlets of 30 items, with one to four testlets recommended per grade level, to measure students' accuracy and automaticity.
COMPefficiency (Comprehension Efficiency)—developed and designed to measure the quality and efficiency of the comprehension processes that occur during reading and the qualities of comprehension product that are left after reading. Presenting both narrative and informational texts, this assessment is computer administered in 7-12 minutes and is available for universal screening and progress monitoring for grades 2-8.

A similar assessment model can be provided for other subjects, such as math and/or social development. In these examples, the assessments are only part of the systems and methods. As provided herein, the systems and methods provide a holistic approach that combines CBM and CAT to transform the way educators measure and monitor student progress in subjects like reading, math and social-emotional behavior.

In addition to assessments, the systems and methods can provide screening and monitoring of students. Further services, such a reporting of various metrics and interventions for students and groups of students and training for educators can also be provided.

In the examples provided herein, the systems and methods are applied using a specific analytical model that involves multiple steps for testing and assessment:
(i) problem identification—identify and acknowledge that a discrepancy exists (i.e., identifying that there is a problem, such as a difference between what is expected and what is occurring), and develop a problem identification statement;
(ii) problem analysis—determine the size of the problem, describe in a way that is measurable, and develop a hypothesis about the cause;
(iii) plan development—develop detailed plans to help the student(s) improve in order to meet grade level expectations;
(iv) plan implementation—implement the plan over a period of time; and
(v) plan evaluation—apply specific progress monitoring assessments to document how well the plan achieves the goal of reducing the gap between current performance and the grade level expectation.
   This model focuses on problem solving, which is reflected in the functionality described herein.

In some examples, the assessments, tests, and/or other educational information are electronically delivered by the systems and methods directly to the students and/or educators. In other examples, the assessments, tests, and/or other educational information are delivered in other manners, such as in a paper format, to the students or educators, and the results of those assessments and/or tests can be inputted into the system for analysis and reporting.

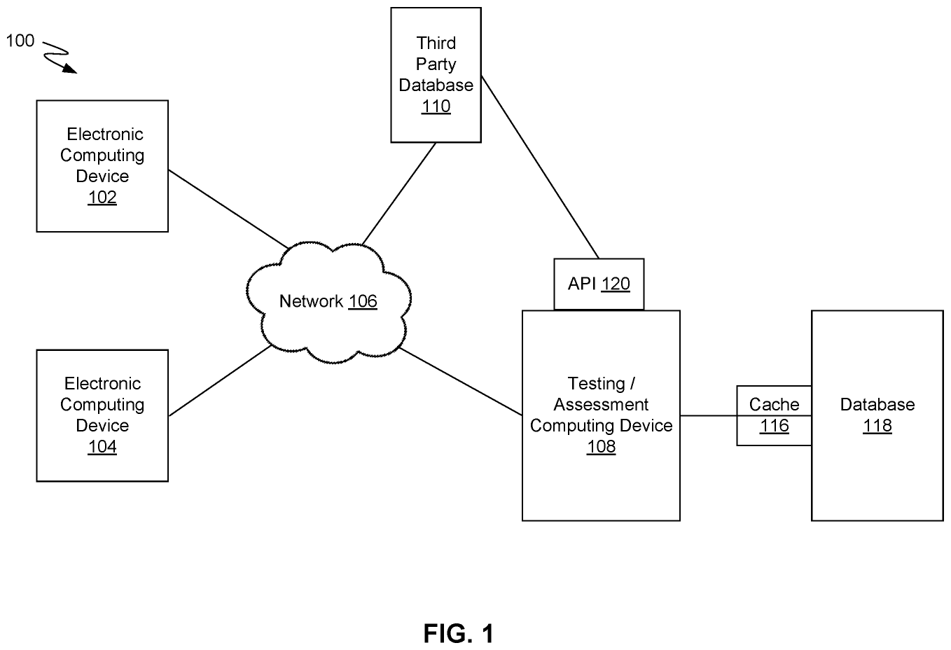

FIG. 1 shows an example system 100 that is programmed to provide testing and/or assessment of students. System 100 includes electronic computing device 102, electronic computing device 104, network 106, testing/assessment computing device 108, third party database 110, and database 118.

The example electronic computing devices 102, 104 are each an electronic computing device of an individual (e.g., educator and/or student) who interacts with the testing/assessment computing device 108. The electronic computing device can be one of a desktop computer, a laptop computer or a mobile computing device such as a tablet computer or a smartphone. The electronic computing devices 102, 104 can be used to perform assessments of students (e.g., by delivering testing information) and can also be used by educators to obtain reporting about students, such as progress monitoring and skills analysis.

The example network 106 is a computer network such as the Internet. Electronic computing devices 102, 104 can communicate with testing/assessment computing device 108 using network 106.

The example testing/assessment computing device 108 is one or more server computing devices. The testing/assessment computing device 108 is programed to provide screening, progress monitoring, skills analysis, and/or informing instruction for students and/or educators. In some implementations, testing/assessment computing device 108 can be a web server that hosts a website for delivery of testing and/or assessment information to students and educators.

In this example, the code that controls the testing/assessment computing device 108 can be segregated into distinct services or modules to allow for modularity of the code. For instance, the code can be divided into the following categories:
Authentication service—service to authenticate users of the testing/assessment computing device 108;
School service—to add/edit district and school settings and data;
Account service—to add/manage educational staff and students;
Roster service—rostering of students;
Setup service—for setting up screening, progress monitoring and interventions;
Benchmark service—to manage and serve benchmarks;
Assessment content service—to serve assessment content;
Scoring service—screening and progress monitoring for administrations;
Reporting service—for providing online reports; and
Datamart service—to serve pre-computed results.
   By segregating the code in this manner, different modules can be modified, removed, and/or added more easily without impacting the functionality of the other modules associated with the testing/assessment computing device 108.

Further, the testing/assessment computing device 108 can provide an application programming interface (API) 120 that allows third party systems (e.g., the third party database 110) to access information and/or functionality provided by the testing/assessment computing device 108. For instance, the third party database 110 could be programmed to access scoring (e.g., anonymized scores) from the testing/assessment computing device 108 for a particular school district. Other configurations are possible.

The example database 118 is one or more databases associated with the testing/assessment computing device 108. The database 118 can store information associated with students and educators, along with data and other information to test and assess those students. The testing/assessment computing device 108 can be programmed to query (e.g. using SQL) the database 118 to obtain data relating to the students and assessments.

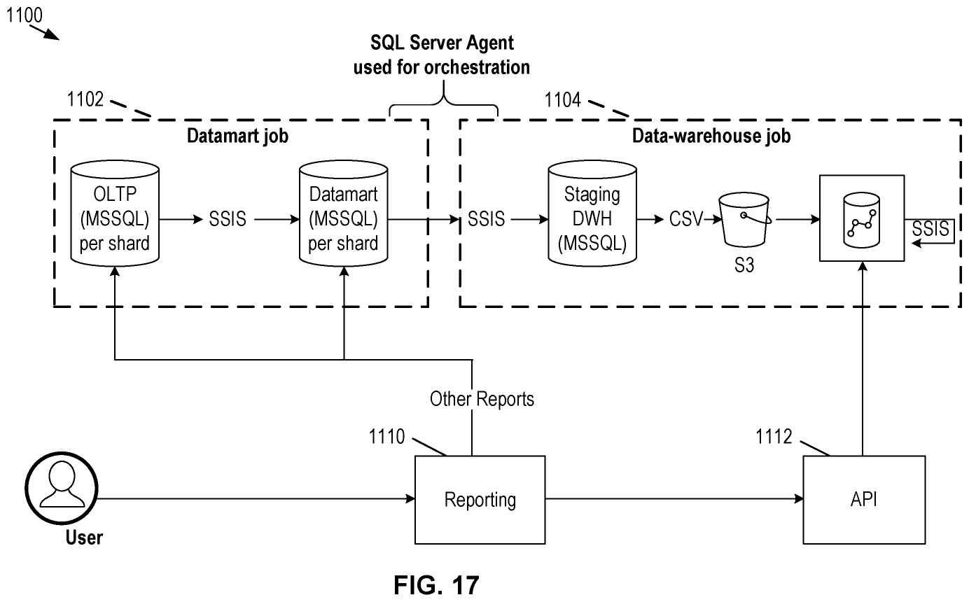

In the example shown, the database 118 is one or more databases that are scalable. For instance, the database 118 can be broken out using a “sharding” model that spreads out multiple instances of the database to allow for scalability. See FIG. 17 below. In addition, the data within the database 118 can be broken into different sets of tables to enhance the accessibility of the data. In this instance, transactional data can be stored in one set of tables, while archival data is stored in a second set of tables, and other content such as specific department-line (pre-computed) data and content can be stored in third and fourth sets of tables. Other configurations are possible.

In the example provided herein, an optional cache 116 is provided for the database 118. The cache 116 improves the performance of the database 118, specifically querying performance by the testing/assessment computing device 108 of the database 118. This is accomplished by storing frequently-used and normally unchanging data in the cache 116 so that reads to the database 118 can be reduced. One example of such data is that associate with some screening or assessment content, in that the content is relatively static and is accessed many times by the testing/assessment computing device 108.

The example third party database 110 can be maintained by a third party and include information relating to students or educators. The third party database 110 can likewise be accessed and queried by the testing/assessment computing device 108 to obtain data relating to the students and assessments using, for example, one or more APIs associated with the third party database 110.

The computing devices are configured to perform more efficiently when analyzing and displaying the information described herein. Specifically, the devices can analyze and display student assessment information more quickly and in a more efficient manner using the configurations and reports described. This allows the student and other educational data to be stored, processed, and displayed in more meaningful manners.

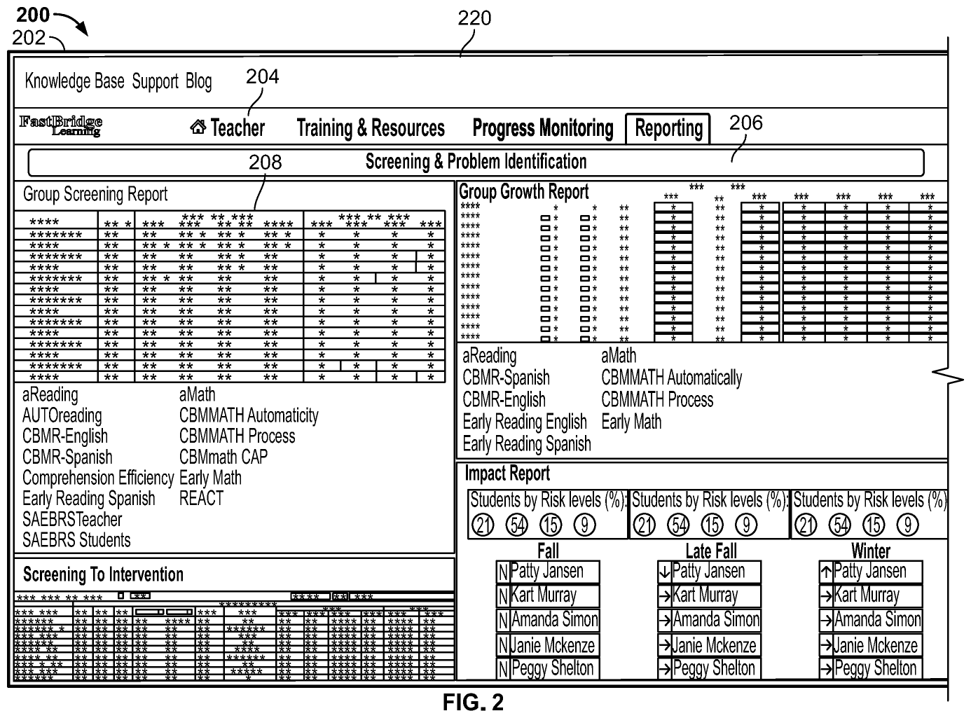

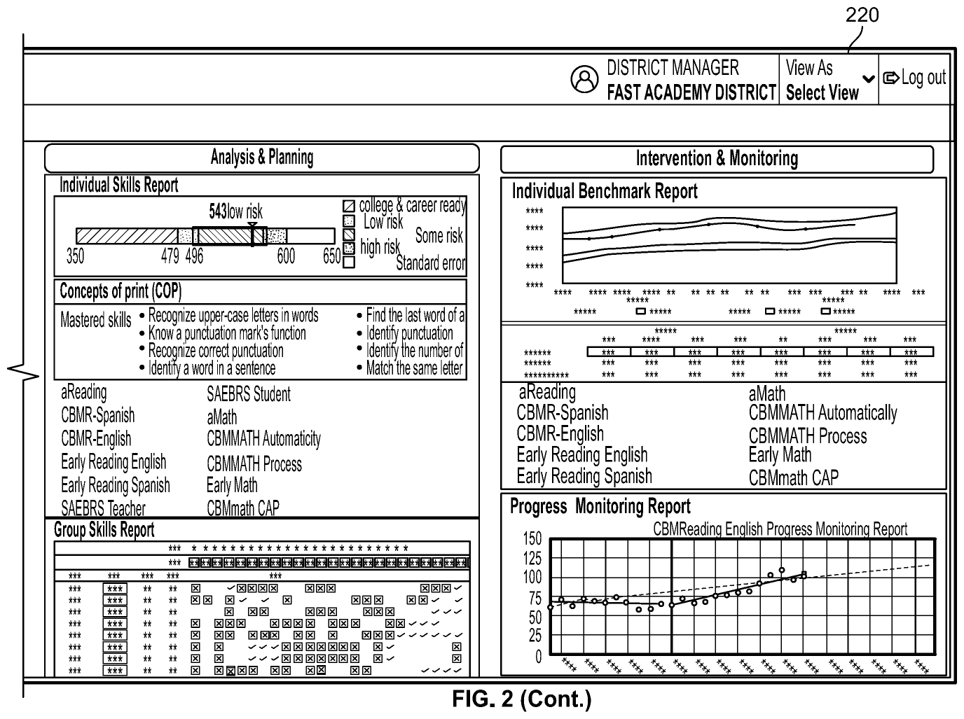

Referring now to FIG. 2, an example interface 200 generated by the testing/assessment computing device 108 is shown. This interface 200 can be accessed, for example, by the electronic computing devices 102, 104 to display various functionality supported by the testing/assessment computing device 108.

The interface 200 includes various functionality. For example, the interface includes a top navigation bar 202 that can be consistent across various interfaces provided by the system 100. This top navigation bar 202 provides access to basic information for the user. In this example, that basic information includes a link to a knowledge base, which provides articles and videos relating to information on how to use the testing/assessment computing device 108. There is also a link to support and blog information that can be used to access other help resources, such as online chat support. In these examples, the top navigation bar 202 is visible on all interfaces so that the user can easily access necessary support information.

The top navigation bar 202 also includes a “view as” control 220 that, when selected, allows the user to change how the view is configured based upon the user's profile. For example, if the user is a teacher, certain information is presented in the interface 200 for that teacher. However, if the user is an administrator, certain other information, such as more summary information for a particular district, might be provided on the interface 200. Based upon permissions and authentication, the user can switch roles by selecting the control 220 to see different information on the interface 200.

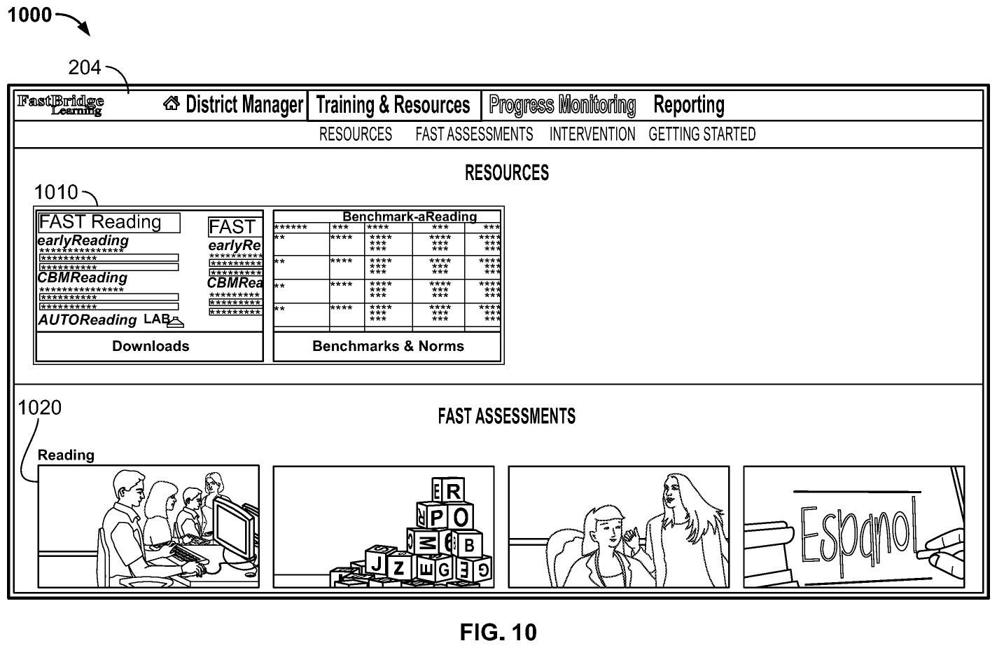

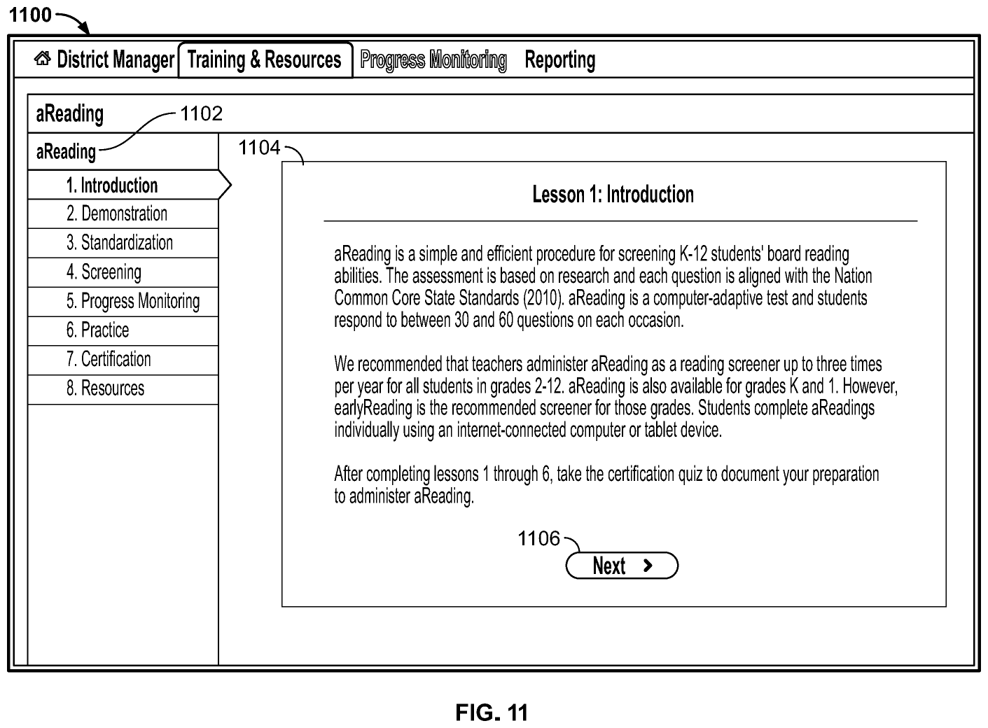

The interface 200 also includes example tabs 204 that organize the information that is shown on the interface 200. The tabs 204 are customized depending on the role of the user, in this instance, a teacher. In this example, the tabs 204 includes a home tab that provides access to profile and class list information. Other tabs 204 include a training & resources tab that provides access to training modules and links to information such as benchmarks and norms, as shown more specifically in reference to FIGS. 10-11. A screening tab provides information about screening tools, like assessments. The progress and monitoring tab provides access to monitoring of various groups associated with the teacher, such as the teacher's class, grade level, school, and/or district.

Finally, the reporting tab of the tabs 204 is selected and illustrated in FIG. 2. The reporting tab provides information associated with reports 208 for the individual, in this instance teacher reports. In this example, the reports 208 are organized into logical groupings so that the user can easily identify desired reports.

For example, the reports 208 in the reporting tab of the interface 200 are broken into groups 206 including a screening & problem identification group, an analysis & planning group, and an intervention & monitoring group. Each group is a logical grouping of the reports 208 that allows the user to more easily find and access a desired report.

In this example, the screening & problem identification group includes reports that lists assessments that are used to screen a particular group of students. The analysis & planning group includes reports that analyze the performance of a particular group of students and assist the educator in planning for the future education of that group of students. And, the intervention & monitoring group includes reports that are used to monitor the progress of a group of students. Once a desired report is identified, the user can select that report to access it.

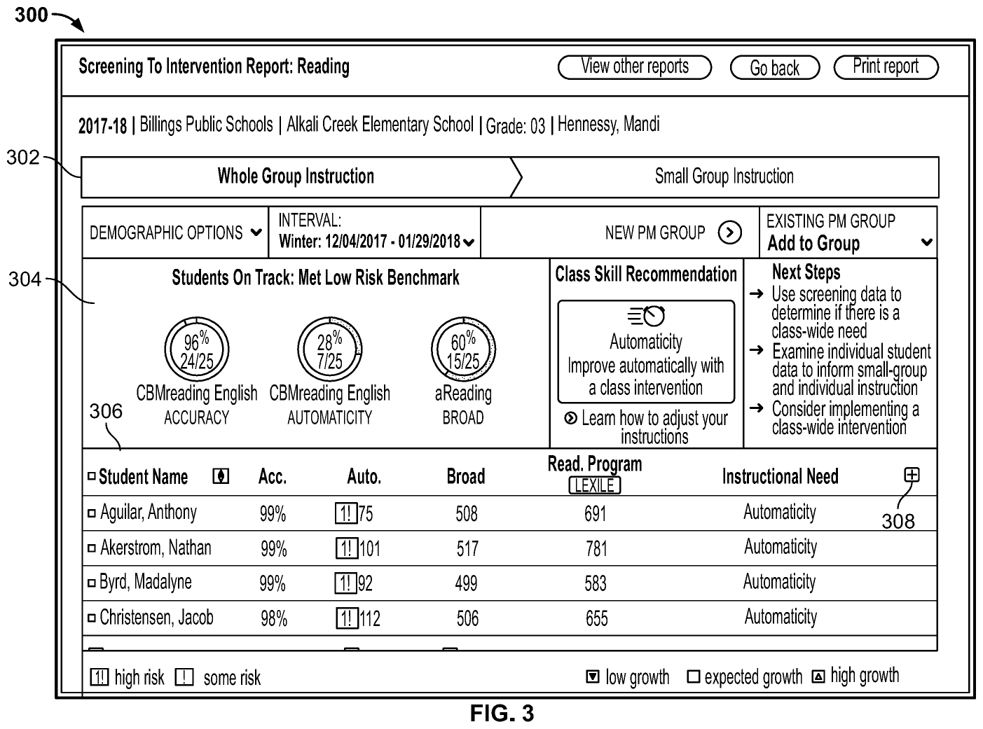

Referring now to FIG. 3, an example report 300 from the reports 208 is shown. In this example, the report 300 is a screening report that assists educators to make decisions about individual, school and district level support. The report can guide educators to applicable interventions, when available, within a school or district to assist students. On the individual level, the report rates the students, based on the benchmarks, in terms of accuracy (refers to whether the student can decode (i.e., sound out and blend) words), automaticity (refers to the extent to which the student can read whole words at first glance) and broad skills (attention to novel word meanings (vocabulary) and general understanding of the entire passage (comprehension)), and a recommendation is made about which area(s) could be addressed on an individual level.

The report 300 includes several sections. A group section 302 allows the user to toggle between various sub-groups listed within the report 300. For example, the group section 302 allows the user to toggle between showing information about the entire group (“Whole Group Instruction”) listed in the report 300 and one or more small groups (“Small Group Instruction”) listed as a subset of the students in the report 300.

A summary section 304 allows the user to easily determine characteristics about the student base shown in the report 300, such as students in a particular class, grade, and/or school. In this example, the summary section 304 includes a “Students on Track” section that shows percentile rankings of those students who are on track (i.e., meet certain low risk benchmarks) as measured by selected assessment, such as accuracy, automaticity, and broad skills.

The summary section 304 also provides a recommendation section, labeled “Class Skill Recommendation,” that lists certain recommendations based upon the skill level of the group. This section provides recommendations on certain interventions that can be used to improve the group's proficiency, and the recommendations can be provided based upon the group dynamics, including group make-up and current proficiency. Finally, the summary section 304 can include a “Next Steps” section that lists recommended next steps for the user based upon the current state of the students listed on the report 300. For example, the Next Steps can include using additional screening assessments to obtain additional information about the students. Although the example shows reading, other assessments can be used, such as math.

The report 300 also includes a detailed section 306 that includes various metrics and information about each student. This can include:
Acc.—accuracy rating—derived from composite score in earlyReading for grades K-1, or from CBM Reading score for grades 2-8;
Auto.—automaticity rating—derived from composite score in earlyReading for grades K-1, or from CBM Reading score for grades 2-8;
Broad—broad skills rating—derived from aReading score; and
Read. Program—score for a selected model (e.g., LEXILE); and
Instructional Needed—Automaticity (or other intervention) indicates what recommended instructional need for the student or if the student is on-track for performance at grade level.

The detailed section 306 is tailored for easier access and consumption of information. Specifically, the detailed section 306 displays certain data about each student, as described above. The detailed section 306 also includes a control 308 (e.g., illustrated as a plus sign) that can be selected to customize the information shown in the columns of the detailed section 306. For example, the control 308 can be selected, and various other metrics and information can be listed to allow the user to show other data. For example, the control 308 can be selected and a suggested intervention field can be selected to add a column to the detailed section 306 that provides a suggested intervention for each student.

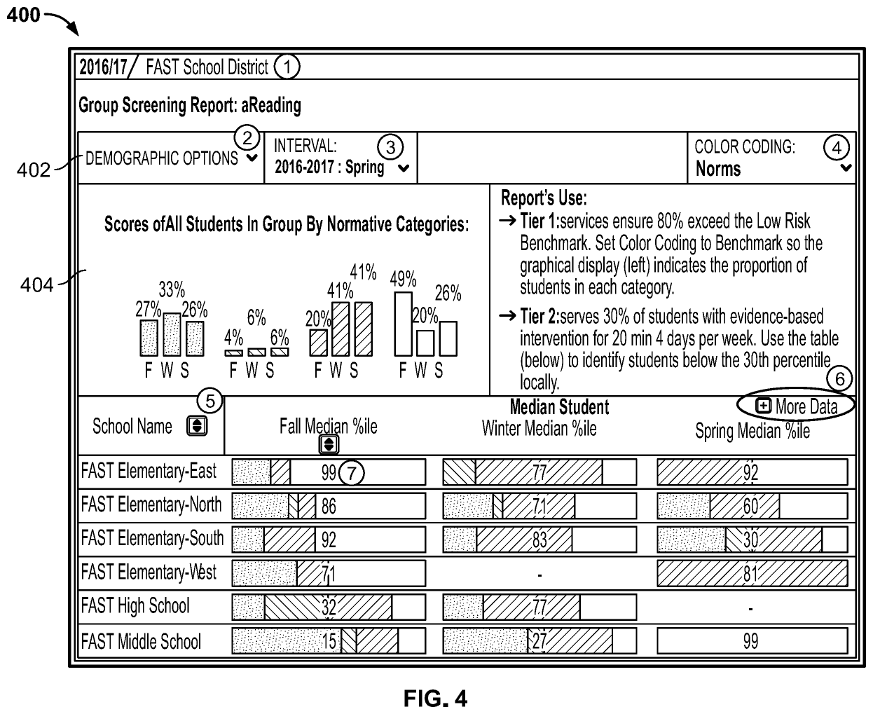

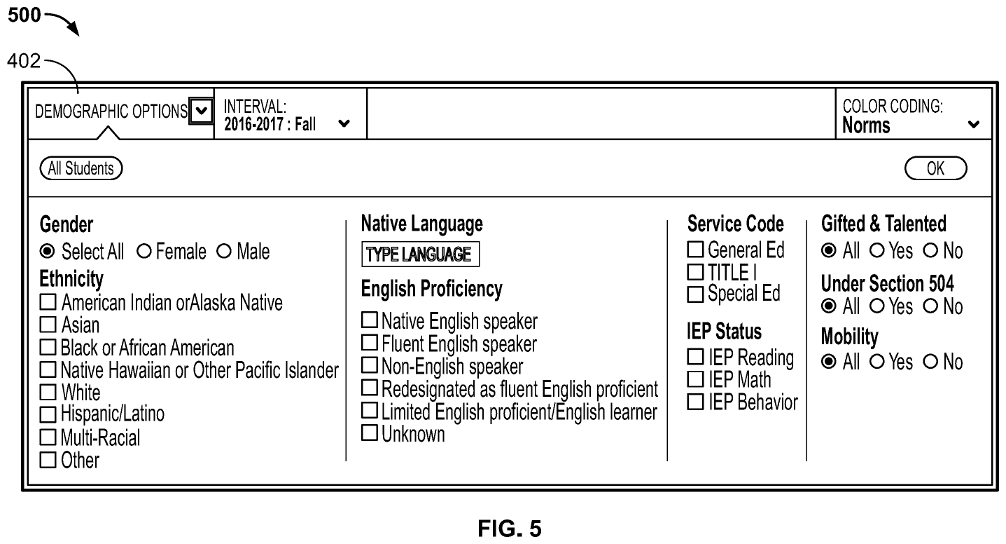

The reports 208 can be modified in other manners to show additional information to the user. For example, referring to FIGS. 4-5, an example group screening report 400 is shown. The group screening report 400 includes a section 404 that includes various summary information about a group of students, such as students in a particular school, school district, state, etc. The group screening report 400 also includes a control 402 that allows the user to modify the demographics of the students shown in the report 400.

Specifically, referring to FIG. 5, once the control 402 is selected, an interface 500 can be provided that allows the user to select different demographics associated with the students listed on the group screening report 400. For example, demographics such as gender, ethnicity, native language, service code, Individualized Education Program (IEP) status, and other metrics, can be selected or deselected to allow the user to customize the group screening report 400. For example, if “Native English speaker” is selected under the English Proficiency section, then the group screening report 400 will be customized to show only summary data in the section 404 from students who are native English speakers.

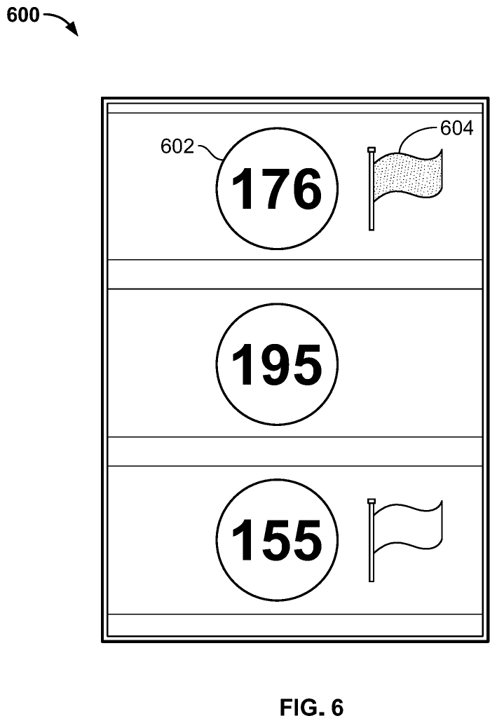

In some examples, data within the reports 208 can be highlighted to provide more information. For example, an excerpt of a report 600 is shown in FIG. 6. In this report 600, certain data 602 is listed about a student or group of students, such as a score associated with a reading assessment. An indicator 604 next to a particular score can mean that the score may need further evaluation.

The indicator 604 signifies that the standard error of measurement (SEM) for that score is larger than usual. In this example, the indicator 604 is a flag that can be color coded. For example, a red flag means the SEM for the student's score was larger than expected and additional testing might be needed. A black flag means that additional testing was done and the administration is completed, but the SEM for the student's score does not meet expectations and a precise score was not obtained. A user can easily discern which students have data with such indicators and take appropriate action, such as with further assessments and/or testing. Other configurations are possible.

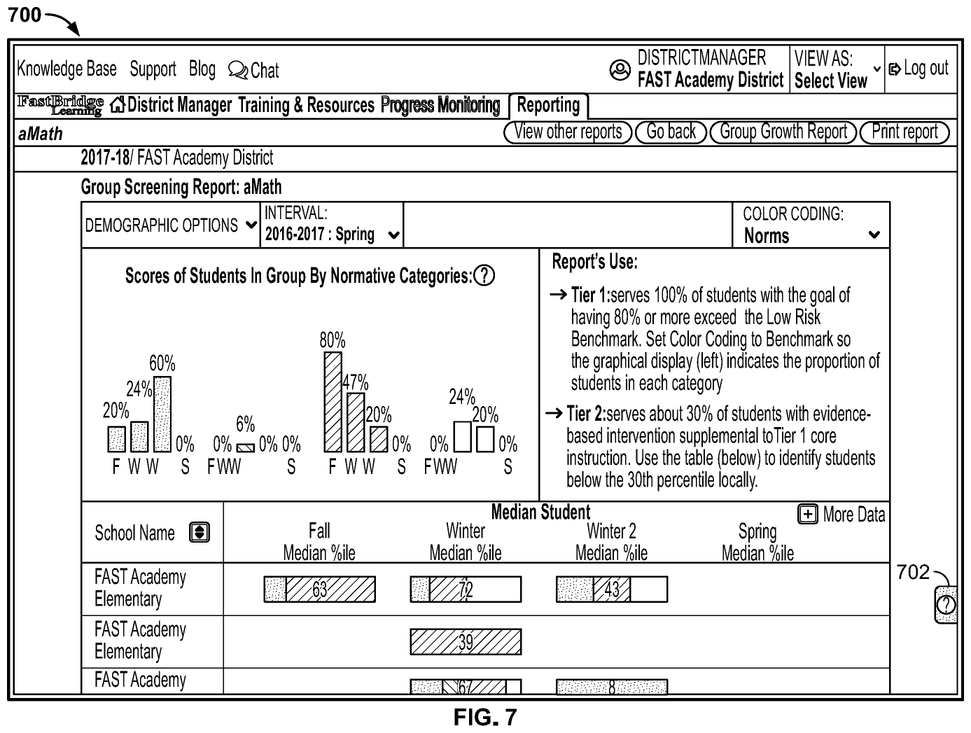

Referring now to FIGS. 7-9, various help functions are available to the user as the user interacts with the systems and methods provided herein. For example, referring now to FIG. 7, an example report 700 relating to a math assessment is shown. In this interface, the report 700 provides a control 702 that includes a question mark (“?”) sign.

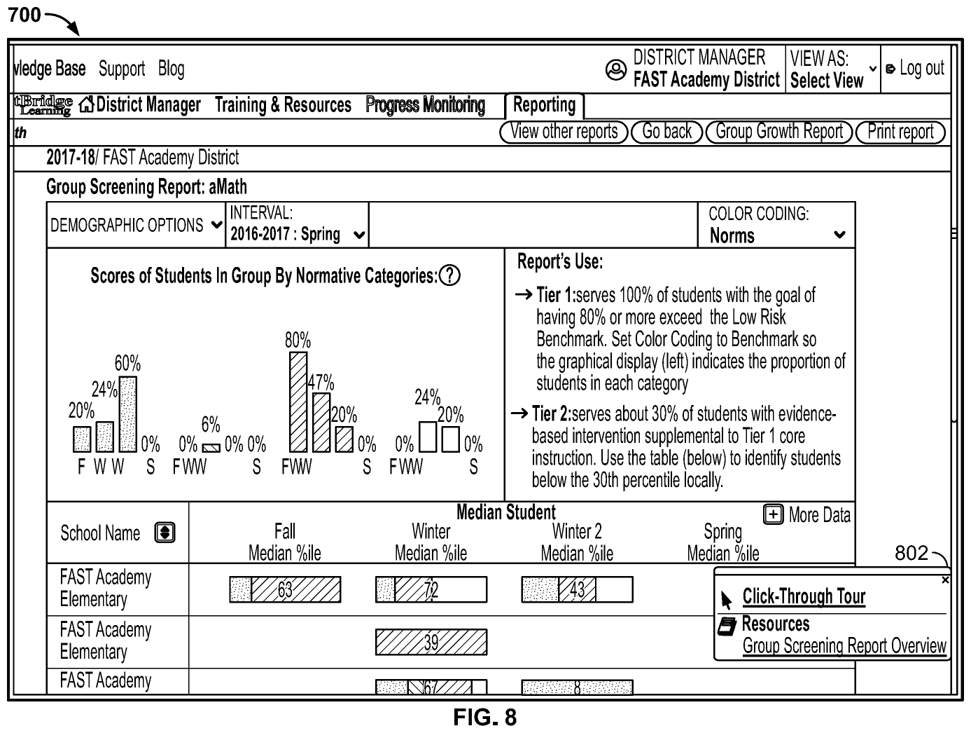

When the user selects control 702, a help box 804 is generated, as shown in FIG. 8. The help box 804 can provide context and information regarding the information on the report 700. The help box 804 is context-specific, in that the contents of the help box is tailored to the information on the report 700 and the information most likely to be helpful to the user. For instance, the help box 804 can provide links that, when selected, take the user to more information about the data on the report 700. This can be, for example, knowledge base or other articles regarding the assessments or other information provided on the report 700.

In addition to such links being provided in help boxes, links can be provided in the reports themselves to other information associated with the information provided on a report. For example, for a reading assessment report, a link may be provided in the report to more information on how the assessment is conducted. By doing so, the user can easily access additional information directly from the report itself, such as the training information shown in FIGS. 10-11.

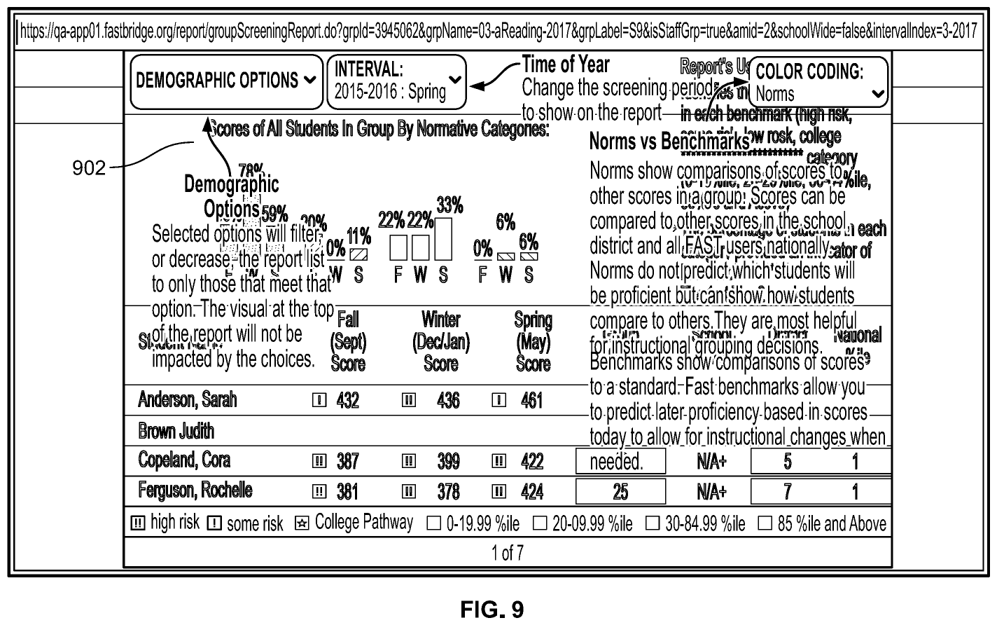

In another example shown in FIG. 9, an overlay 902 is provided on top of the selected report. This overlay 902 is typically semi-transparent and provides information about the contents of the report. In the example shown, this information can include text describing aspects of the report (e.g., demographic options), as well as arrows and other indicators that help the user understand the layout, context, and information provided by the report. The overlay 902 provides an intuitive way to convey this information to the user.

Referring to FIGS. 10-11, additional training information can be provided by the testing/assessment computing device 108. In the example shown in FIG. 10, the training & resources tab of the tabs 204 is selected to access more training information on an interface 1000. The interface 1000 includes a resources section 1010 and an assessments information section 1020.

The resources section 1010 includes links to downloads and other benchmarking and normalization information. The user can select these links for additional information. The assessments information section 1020 presents training videos organized in a grid-like fashion that is easily accessible to the user. The user can select one or more training videos from the assessments information section 1020 to learn more about particular assessment information.

Other sections (not shown) can include intervention, which provides training materials on interventions for students. Further, a getting started section provides materials on how to start using the system and/or the functionality provided therein. Other configurations are possible.

FIG. 11 shows additional information selected from the resources section 1010 in the interface 1000 about a specific assessment. An interface 1100 is provided that includes information 1104 that is split into different sections. A section list 1102 is provided. The user can select a control 1106 to move to the next section of information about the assessment. Further, the user can select one of the sections in the section list 1102 to jump to that particular section.

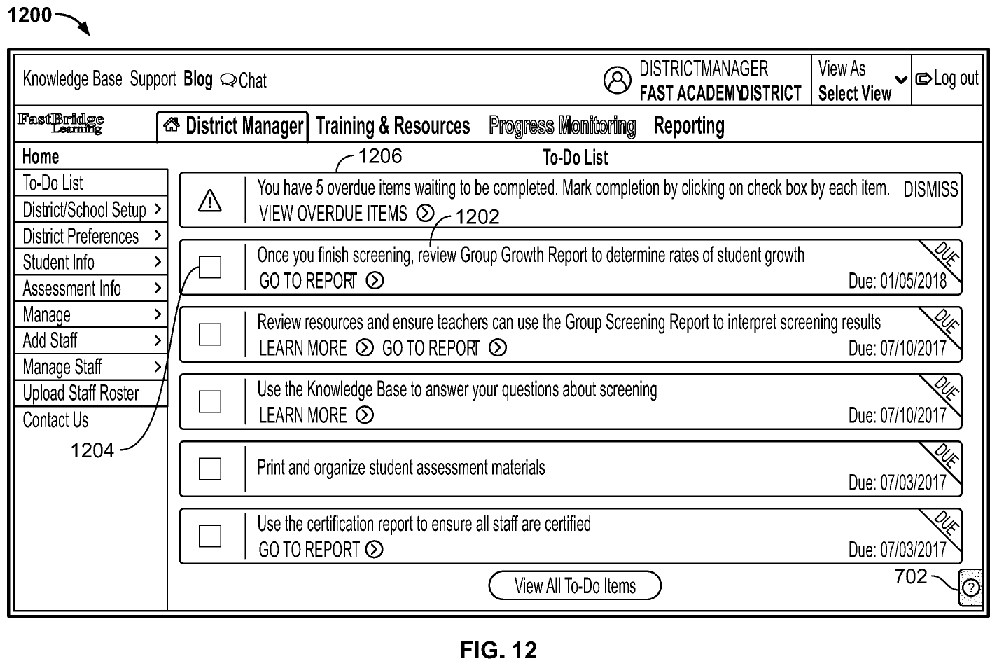

Referring now to FIG. 12, an example to-do list 1200 is shown. In this example, the items 1202 on the list 1200 can be auto-generated based upon various attributes, such as the user role, user activity, and/or time of year. For example, if a certain assessment is given at the beginning of a school year, items 1202 can be generated automatically on the list 1200 for follow-up assessments at several future times in the school year.

Each item 1202 can include a subject that identifies the particular action to be taken. The item 1202 can also include a deadline and one or more links to more context about the item 1202. For example, if the item 1202 relates to an assessment, a link to the report for that assessment is provided on the item 1202 so the user can select the link to see the report. The user can select a control 1204 to indicate that an item 1202 has been completed. Or, the item 1202 can automatically be indicated as complete once the testing/assessment computing device 108 determines that an action has been taken by the user (e.g., a particular assessment has been given by the user). Further, an alert box 1206 is provided that indicates which items 1202, if any, are overdue or otherwise need attention.

As noted, the items 1202 can be automatically generated by the testing/assessment computing device 108. In some examples, items 1202 can also be manually created by the user. Other configurations are possible.

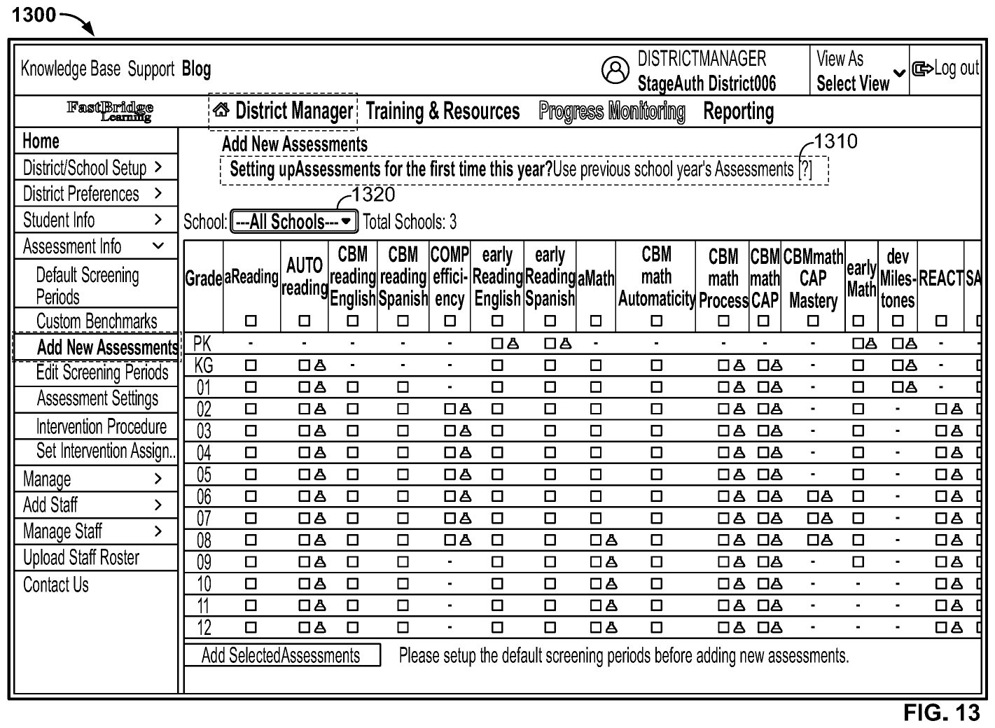

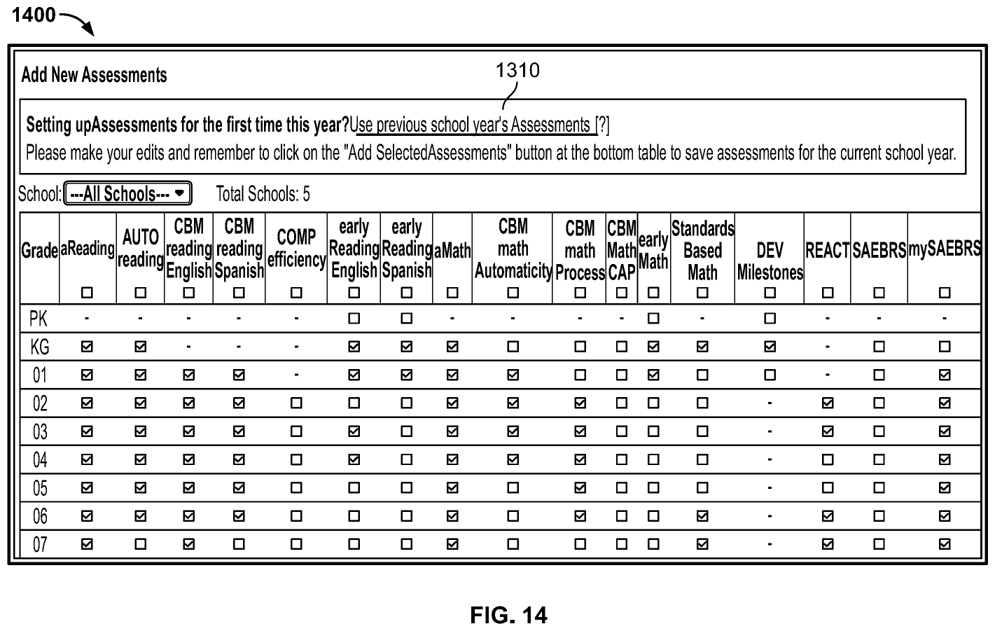

Referring now to FIGS. 13-14, in the example provided, the testing/assessment computing device 108 allows a user to segregate the testing and assessments by school year. In this example, each school year can be treated separately, and a user can import certain information from previous years to assist it the setup for a particular year.

An interface 1300 in FIG. 13 shows the setup for a particularly group of schools or school for a school year. The user can select a control 1302 to access a dropdown to determine which schools (e.g., “All Schools” shown) within a group to apply the selected assessments. The user can select checkboxes on the interface 1300 to pick assessments for the school for the specified school year.

If desired, the user can select a control 1310 to import assessments from a previous school year. When the control 1310 is selected to import previous assessments, an interface 1400 is shown with a grid that auto-populates with checkmarks for those assessments. See FIG. 14. The user can select or de-select further assessments by clicking the checkbox to toggle the checkmark on or off. In this manner, the user can import assessments from previous school years and further customize the assessments given for the current school year.

In some examples, the testing/assessment computing device 108 also provides analytics support for usage tracking and reporting. In this example, detailed user behavior is collected by the testing/assessment computing device 108. This can be used, for example, to provide intelligent recommendations, build profiles, and/or provide coaching with the goal of providing better guidance to educators and improving student outcomes.

For instance, user behavior can be captured and positive outcomes identified. When those positive outcomes are identified, the behaviors can be reviewed so that future users can be provided with recommendations. In some examples, machine learning is used to look at the behaviors and outcomes to identify models to guide users with recommendations. Those recommendations can be presented, for example, as next steps, such as those in the “Next Steps” section of the summary section 304 of the report 300 in FIG. 3.

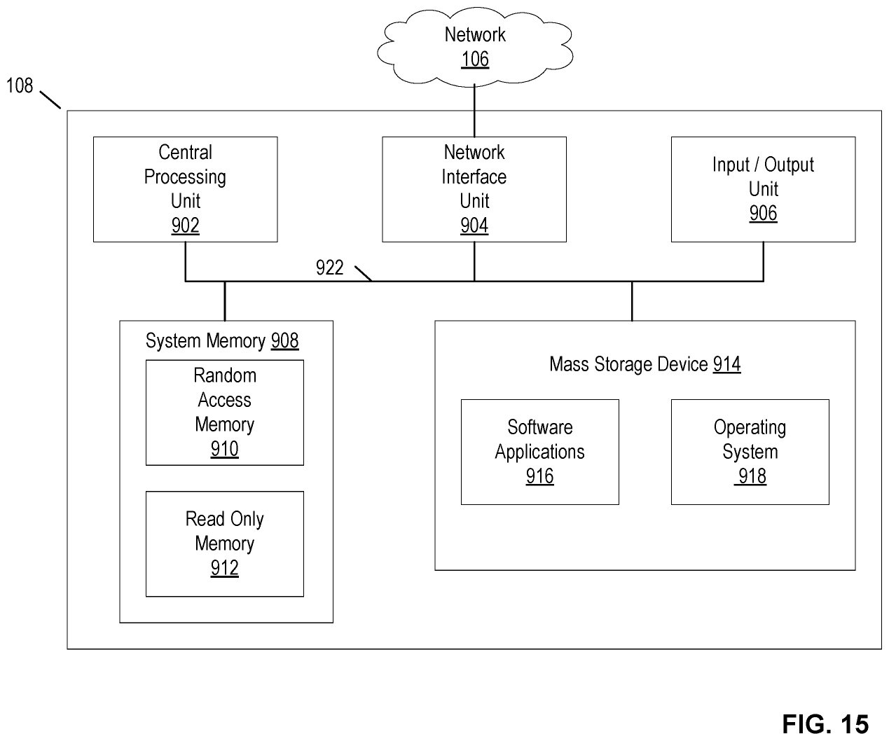

As illustrated in the example of FIG. 15, testing/assessment computing device 108 includes at least one central processing unit (“CPU”) 902, also referred to as a processor, a system memory 908, and a system bus 922 that couples the system memory 908 to the CPU 902. The system memory 908 includes a random access memory (“RAM”) 910 and a read-only memory (“ROM”) 912. A basic input/output system that contains the basic routines that help to transfer information between elements within the testing/assessment computing device 108, such as during startup, is stored in the ROM 912. The testing/assessment computing device 108 further includes a mass storage device 914. The mass storage device 914 is able to store software instructions and data. Some or all of the components of the testing/assessment computing device 108 can also be included in retailer server computing device 112 and the other computing devices described herein.

The mass storage device 914 is connected to the CPU 902 through a mass storage controller (not shown) connected to the system bus 922. The mass storage device 914 and its associated computer-readable data storage media provide non-volatile, non-transitory storage for the testing/assessment computing device 108. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the testing/assessment computing device 108.

According to various embodiments of the invention, the testing/assessment computing device 108 may operate in a networked environment using logical connections to remote network devices through the network 106, such as a wireless network, the Internet, or another type of network. The testing/assessment computing device 108 may connect to the network 920 through a network interface unit 904 connected to the system bus 922. It should be appreciated that the network interface unit 904 may also be utilized to connect to other types of networks and remote computing systems. The testing/assessment computing device 108 also includes an input/output controller 906 for receiving and processing input from a number of other devices, including a touch user interface display screen, or another type of input device. Similarly, the input/output controller 906 may provide output to a touch user interface display screen or other type of output device.

As mentioned briefly above, the mass storage device 914 and the RAM 910 of the testing/assessment computing device 108 can store software instructions and data. The software instructions include an operating system 918 suitable for controlling the operation of the testing/assessment computing device 108. The mass storage device 914 and/or the RAM 910 also store software instructions and software applications 916, that when executed by the CPU 902, cause the testing/assessment computing device 108 to provide the functionality of the testing/assessment computing device 108 discussed in this document. For example, the mass storage device 914 and/or the RAM 910 can store software instructions that, when executed by the CPU 902, cause the testing/assessment computing device 108 to display received data on the display screen of the testing/assessment computing device 108.

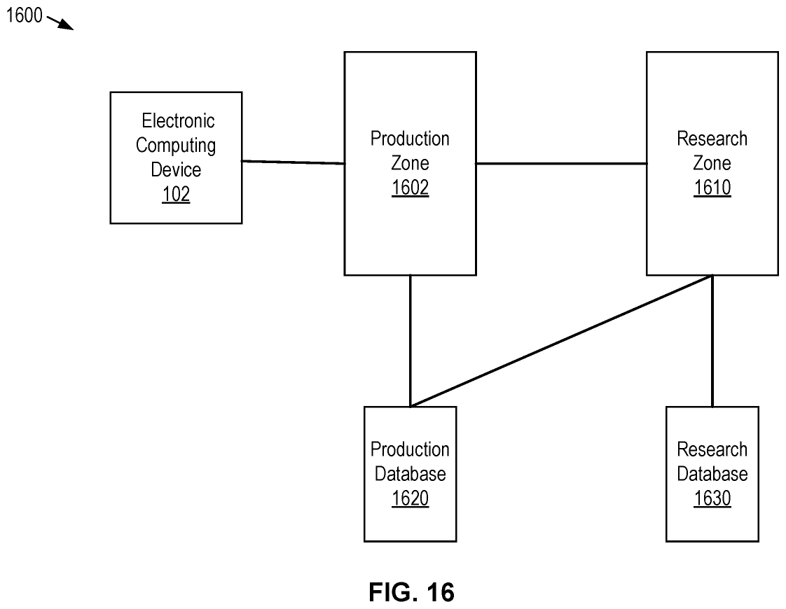

Referring now to FIG. 16, another example system 1600 that is programmed to provide testing and/or assessment of students is shown. In this example, the electronic computing device 102 can access a production zone 1602 with a production database 1620. This environment is similar to the system 100 described above.

In addition, the system 1600 includes a research zone 1610 with a research database 1630 with computing resources that are only accessible by certain client devices have the proper credentials. In this example, the research zone 1610 is a separate software development platform used for early-stage development, field testing, beta testing, concept maturation, and/or evidence-based validation of new content and technology features. It can be used to develop and validate the feasibility of a technology-based or technology-delivered product or service offering in terms of data, science, technology feasibility, and/or market adoption.

In this example, the research zone 1610 and the research database 1630 are hosted on a separate computing environment. For instance, a separate cloud computing environment with separate application and database servers can be used to host the research zone 1610. In this example, the research zone 1610 and the research database 1630 are hosted in a cloud computing environment provided by Amazon Web Services, Inc. of Seattle, Wash.

For example, a new testing protocol can be implemented on the research zone 1610. The clients with proper credentials can access and use the new testing protocol and even administer the protocol as appropriate. The protocol can be used to access data from both the research database 1630 and the production database 1620.

By segregating the new testing protocol, the system 1600 can control who accesses it and administers it. Also, any technical issues associated with the new testing protocol can be segregated to the research zone 1610, so that issues do not impact the production zone 1602. Many other configurations are possible.

Referring now to FIG. 17, a data warehousing environment 1100 is shown. In this example, the environment 1100 can be used to store data for the systems 100, 1600, such as the databases 118, 1620.

In this example, the data warehousing environment 1100 allows for reporting at various levels (e.g., state and consortium level) with faster reporting performance. The user can make a request for a report, and a computing device 1110 can access a datamart 1102 and a data warehouse 1104 to generate the data for the requested report.

More specifically, the datamart 1102 depicts a single shard, which has lower level data (e.g., district level or lower). A shard is a multi-tenant model having data for multiple jurisdictions (e.g., districts), but all of a jurisdiction's data can be stored in one shard. In order to allow reporting at granularity levels higher than that of a district, data from individual shards are aggregated into the data warehouse 1104. An application programming interface (API) 1112 can be used to then serve higher level data requests (e.g., serve state and consortium level) by accessing the data warehouse 1104. For instance, the computing device 1110 can use the API 1112 to access the data warehouse 1104 to serve various requests that show state and consortium level reports to the user.

Various technical advantages are associated with the systems described herein. For example, the example architectures provided result in systems with greater efficiency at assessing, storing, and reporting data associated with the assessment of students. Further, the example user interfaces provide a more efficient manner for displaying and manipulating the assessment data.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A system for assessing student progress, the system comprising:
a processor; and
memory encoding instructions which, when executed by the processor, cause the system to:
assist in the identification and analysis of a student performance issue;
develop a plan to address the student performance issue by improving student performance;
assist in implementation of the plan over time; and
evaluate success of the plan in addressing the student performance issue by monitoring assessments of students.

2. The system of claim 1, further comprising a database model for storing data associated with the student progress, the database model being a sharded database model.

3. The system of claim 2, wherein the database model is broken into a set of tables including: transactional tables storing transactional data; archive tables storing older data; and content tables storing content to be served to a client.

4. The system of claim 1, further comprising instructions which, when executed by the processor, causes the system to provide a user interface with one or more controls which allow for selection of one or more demographics of students to filter data.

5. The system of claim 4, wherein the controls include one or more of: gender, ethnicity, native language, service code, and Individualized Education Program (IEP) status.

6. The system of claim 1, further comprising instructions which, when executed by the processor, causes the system to:
segregate assessments by year; and
allow for selection of a prior year when defining assessment settings for a current year to import information into the current year.

7. The system of claim 1, further comprising:
a production zone housing production assessments and data; and
a research zone housing development assessments and data.

8. The system of claim 7, wherein the development assessments and data includes one or more of early-stage development, field testing, beta testing, concept maturation, and evidence-based validation of new content and technology features.

9. A system for assessing student progress, the system comprising:
a processor; and
memory encoding instructions which, when executed by the processor, cause the system to:
a model for assessment development, including:
assist in the identification and analysis of a student performance issue;
develop a plan to address the student performance issue by improving student performance;
assist in implementation of the plan over time; and
evaluate success of the plan in addressing the student performance issue by monitoring assessments of students;
a database model for storing data associated with the student progress, the database model being a sharded database model; and
a user interface to allow for selection of filters to filter data associated with the assessments of students.

10. The system of claim 9, wherein the database model is broken into a set of tables including: transactional tables storing transactional data; archive tables storing older data; and content tables storing content to be served to a client.

11. The system of claim 9, further comprising instructions which, when executed by the processor, causes the system to provide the user interface with one or more controls which allow for selection of one or more demographics of students to filter data.

12. The system of claim 11, wherein the controls include one or more of: gender, ethnicity, native language, service code, and Individualized Education Program (IEP) status.

13. The system of claim 9, further comprising instructions which, when executed by the processor, causes the system to:
segregate assessments by year; and
allow for selection of a prior year when defining assessment settings for a current year to import information into the current year.

14. The system of claim 9, further comprising:
a production zone housing production assessments and data; and
a research zone housing development assessments and data.

15. The system of claim 14, wherein the development assessments and data includes one or more of early-stage development, field testing, beta testing, concept maturation, and evidence-based validation of new content and technology features.

16. A method for assessing student progress, the method comprising:
assisting in the identification and analysis of a student performance issue;
developing a plan to address the student performance issue by improving student performance;
assisting in implementation of the plan over time;
evaluating success of the plan in addressing the student performance issue by monitoring assessments of students; and
providing user interface with one or more controls which allow for selection of one or more demographics of students to filter data.

17. The method of claim 16, further comprising storing data in a sharded database model.

18. The method of claim 17, wherein the database model is broken into a set of tables including: transactional tables storing transactional data; archive tables storing older data; and content tables storing content to be served to a client.

19. The method of claim 16, further comprising:
segregating assessments by year; and
allowing for selection of a prior year when defining assessment settings for a current year to import information into the current year.

20. The method of claim 16, further comprising:
forming a production zone housing production assessments and data; and
forming a research zone housing development assessments and data.
